(19) United States
(12) Patent Application Publication
(10) Pub. No.: US 2012/0274535 A1
(43) Pub. Date: Nov. 1, 2012

(54) RFID Microstip Interrogator Antenna System

(76) Inventor: Daniel D. Deavours, Lawrence, KS (US)

(21) Appl. No.: 13/459,634

(22) Filed: Apr. 30, 2012

Related U.S. Application Data
(60) Provisional application No. 61/481,029, filed on Apr. 29, 2011.

(51) Int. Cl. H01Q 1/36; H01Q 1/48

(52) U.S. Cl. 343/848; 343/905

(57) ABSTRACT

The present invention overcomes the above-described and other problems by providing an improved edge-fed microstrip patch antenna, a dielectric substrate with integrated ground plane and enclosure that with a printable surface. An RFID microstrip patch antenna (21) system produces an antenna that is significantly less expensive to manufacture and install than existing commercial solutions. In doing so, the present invention enables the use of commodity, low cost products such as corrugated paperboard foils and extruded polystyrene and assembly methods such as graphics printing.

### RELATED APPLICATIONS

The present non-provisional patent application is related to and claims priority benefit of an earlier-filed provisional patent application titled Composition and Enclosure of Inexpensive Microstrip Antenna, Ser. No. 61/481,029, filed Apr. 29, 2011. The identified earlier-filed application is hereby incorporated by reference into the present application.

### FIELD OF INVENTION

This invention pertains to the area of wireless communications, more specifically to RF communications, even more specifically to radiofrequency identification (RFID) in the ultra high frequency (UHF) range, even more specifically a patch-like antenna for transmitting and receiving RF communications for UHF RFID, and most specifically to a low-cost implementation of such an antenna and method for making the same. While UHF RFID is the primary intended purpose of the invention, the invention may be used in other applications with a comparable range of frequency is required (e.g., 300 MHz to 10 GHz).

### BACKGROUND OF INVENTION

An RFID system typically consists of an interrogator (or “reader”), a transponder (or “tag”), and possibly a host system such as a computer and network that controls the interrogator. The transponder is further comprised of an antenna and an integrated circuit (IC). A passive RFID system is one in which the transponder does not have any internal power source, but harvests RF energy from the interrogator signal. The interrogator thus provides power, timing, and instructions to the transponder. The tag communicates to the reader by changing the impedance of the IC, thereby changing the impedance match between tag antenna and IC. In an ultra high frequency (UHF) RFID system, electromagnetic radiation is typically used to couple the interrogator and transponder, so the IC changes in impedance changes the scattering characteristics of the tag, which can be detected at the reader.

The UHF RFID interrogator typically communicates with transponders by using an reader antenna, which converts electrical energy in a transmission line into electromagnetic energy that propagates through space in what are commonly called radio waves. In a monostatic system, the same reader antenna is used to also receive radio waves and convert them into energy on to a transmission line, such as a coaxial cable. In a bistatic system, separate reader antennas are used to transmit and receive RF energy.

Commonly, UHF RFID interrogators use a microstrip (or “patch”) antenna. A patch antenna has the utility of having a modest gain of six to 10 dBi of directionality and a cone-shaped radiation pattern with a beam-width of about 60 to 80 degrees, which is useful for interrogating tags within a well-defined region. Patch antennas also have a low profile so as to minimize protrusion from any attachment point. Patch antennas can also be made to produce a variety of different kinds of polarization, and in particular, circular polarization.

Microstrip antennas are well known in the art, including those producing circular polarization (CP). A microstrip antenna consists of a ground plane (large metal plane), radiating element parallel to the ground plane (the “antenna”), some dielectric interposed between the antenna and ground plane (possibly air), and a feed. Numerous geometries for the antenna are possible, including square, rectangle, circle, and triangle. It is know that exciting two orthogonal radiating modes, each with a resonant frequency slightly offset in frequency, can produce CP radiation. One method to do this is to use a rectangular patch antenna, while another is to use a symmetric patch, such as a square or circle, and introduce slots to perturb one mode. It is common for coaxial transmission lines to couple to the antenna through a probe feed. Alternatively, microstrip transmission lines can couple to the antenna through a variety of ways, including edge coupled, proximity coupled (or electromagnetically coupled), or aperture-coupled. All of these techniques are well known in the art.

Antennas can be composed any number of ways. UHF RFID antennas are commonly coupled to a coaxial transmission line by a probe feed, which means that the coaxial cable protrudes from the back side of the antenna through the ground plane and connects to the antenna by a wire probe. Typically, the antenna is a metal plate cut through some precision method, such as laser or plasma cutters. Alternatively, photolithographic methods for printed circuit board (PCB) methods may be used to accurately construct the antenna, and/or any coupled microstrip transmission lines. Typically, antennas are constructed with a stainless steel plate for a ground plane, Teflon or other plastic spacers to produce an air dielectric substrate, and a rugged plastic radome (cover). Other design elements may be included to produce a water-tight seal and UV-resistant polymers so that the antenna can be used outdoors. It should be noted that many RFID reader antennas are deployed indoors. Furthermore, the ground plane may be fitted with threaded holes or protruding threaded rods for mounting hardware.

The cost of RFID antennas can be expensive, commonly ranging from $30 to $350. Mounting hardware further increases the cost, and in some instances, the cost of installation can greatly exceed the cost of the hardware. Thus, the cost of the antenna, mounting hardware, and cost of installation are a significant source of inefficiency in many modern UHF RFID systems.

The current methods of manufacturing microstrip antennas are significantly complex and have a number of limitations. The antennas tend to be relatively heavy, weighing between 1 to 4 pounds (0.5 to 2 kg), which affects the cost of shipping and installation. They tend to be brittle and intolerant to shock or dropping from heights greater than 3 feet. The external enclosure or radome is typically made of plastic, such as ABS, and are difficult to customize colors in small quantities. Graphics and writing on the antenna require an extra label to be affixed antennas enclosure. When shipping, they tend to require individualized packaging, meaning that fewer can be packaged on to a pallet, which increases shipping costs. They tend to be hand-assembled, which affects cost and speed of manufacture. Many antennas have rear connectors, which make them difficult to mount, flush against a wall.

### SUMMARY OF THE INVENTION

The present invention overcomes the above-described and other problems by providing an improved edge-fed microstrip patch antenna, a dielectric substrate with integrated ground plane and enclosure that with a printable surface. The antenna system produces an antenna that is significantly less expensive to manufacture and install than existing commercial solutions. In doing so, the present invention enables the use of commodity, low cost products such as paperboard, foils, and extruded polystyrene and assembly methods such as graphics printing.

The preferred embodiment consists of: die cut antenna patterns from foils or foil-laminate tapes, which is further comprised of the radiating element and a length of transmission line for impedance matching; expanded or extruded polystyrene (EPS or XPS) dielectric substrate; aluminum foil ground plane; a simple mounting bracket; an RF connector; optionally, a paperboard or plastic carton enclosure; and optionally, the antenna fitted with shoulder washers, shock cord, and hooks for easy installation in above industrial racking.

The invention has the following advantages. 1) The antenna is light weight; the preferred embodiment weighing approximately 8 ounces (226 grams). 2) The materials and method of assembly make the antenna very rugged. They can be dropped from almost any height and stepped with minimal performance degradation. 3) The surface is a printable material, which means that the surface can easily be colored or text added using a number of printing technologies. 4) The rectangular geometry affords tight stacking for dense, economical shipping. 5) The antennas can use highly automated methods to rapidly assemble large numbers of antennas. 6) The antenna is fed along the edge, reducing the profile of the antenna, and making it more robust in its intended operating environment. 7) The antenna can be significantly less expensive to manufacture. 8) An integrated hanger kit reduces installation costs and increases the robustness of the antenna in its intended environment.

The steps required to install an antenna with the hanger kit is straightforward. He or she (hereafter “he” may mean either “he” or “she”) opens a box of antennas, removes one antenna, locates the position to install the antenna on a rack, and places it in position with one hand. With the other hand, he may hook each of the four hooks on to the wire mesh of the rack. Once all four hooks are hung, the installer connects the RF cable, and the antenna installation is complete. This can be done in two to three minutes compared to the 15 to 30 minutes it takes with standard antennas and mounting kits.

The cord of the hanger kit provides approximately 1.5 inches of relief from the wire mesh. This allows the antenna to reside in the approximately three inch region below the industrial racking that is protected by the front cross member of the rack. Thus, to be disturbed by placing product in or taking product out of the rack, an operator must, for example, place a pallet into the rack and then raise the pallet. This is a relatively rare occurrence. Even so, relatively mild disturbances will only move the antenna a short distance, while the antenna will still maintain its horizontal and downward positioning, due to being suspended by bungee cords from hooks. This illustrates one aspect of the robustness of the invention.

### BRIEF DESCRIPTION OF DRAWINGS

The following drawings form part of the present specification and are included to further demonstrate certain aspects of the present invention. The figures are examples only, and do not limit the scope of the invention.

FIG. 1 is an isometric view of the present invention with many of its constituent parts.

FIG. 2 is an isometric view the dielectric substrate.

FIG. 3 is an isometric view of the dielectric substrate machined to functionally accept a bracket and pattern.

FIG. 4 shows the dielectric substrate with holes machined for hanger kit.

FIG. 5 is an isometric view the pattern.

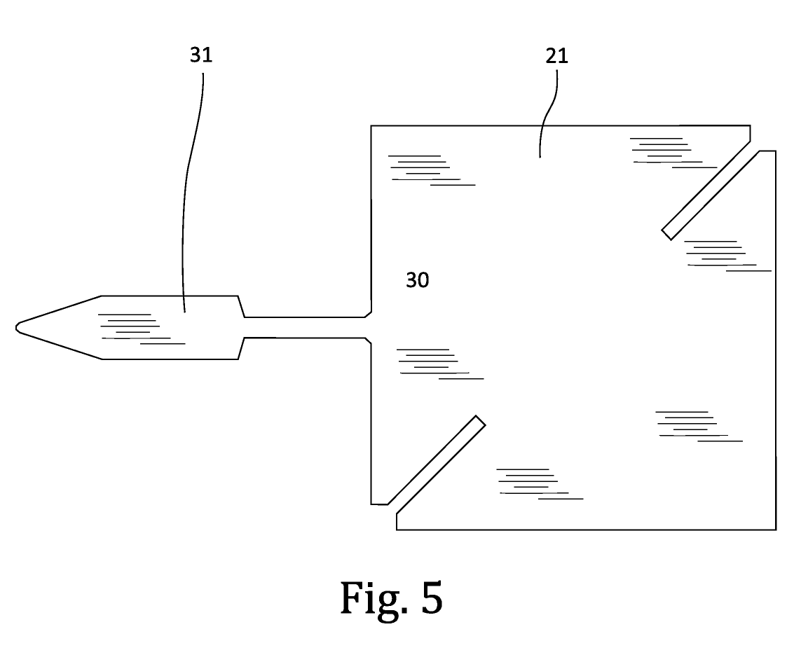

FIG. 6 is an isometric view the bracket.

FIG. 7 is an isometric view the RF connector.

FIG. 8 is an isometric view of a Hanger Kit assemblies.

FIG. 9 is an isometric view the corrugated paperboard box enclosure.

### DETAILED DESCRIPTION

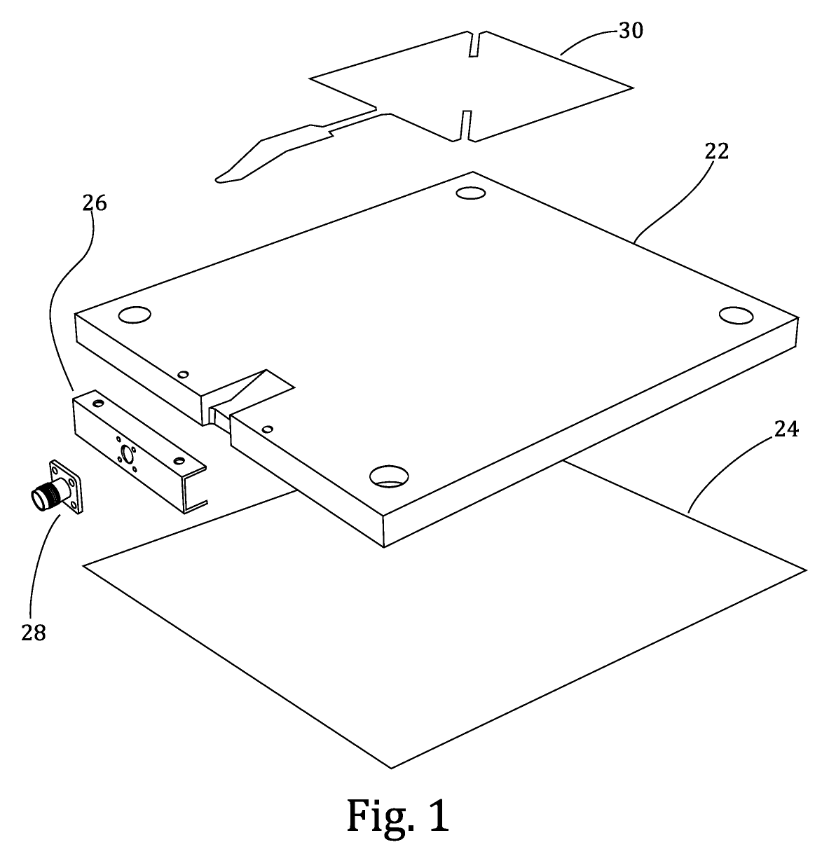

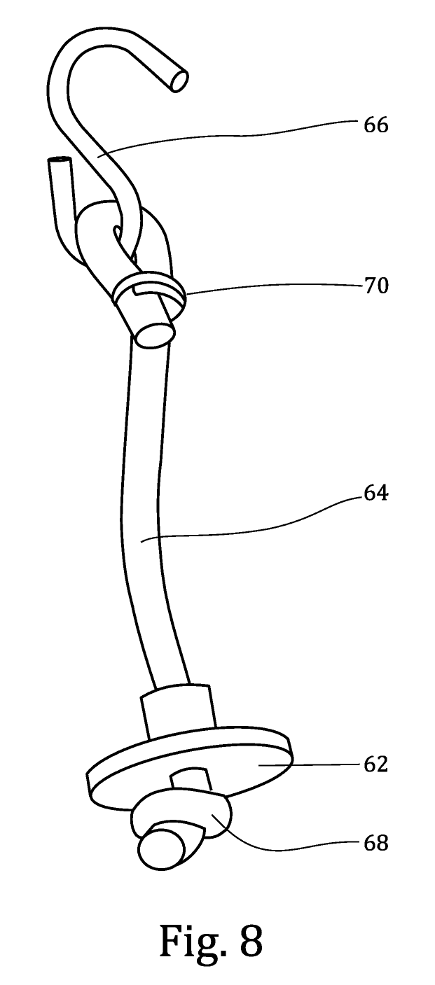

With reference to the figures, an RFID microstrip interrogator antenna system is herein described, the embodiment of the invention consists of the following elements: an base antenna (20), an optional enclosure (40), and an optional hanger kit (60). Referring to FIG. 1, the base antenna consists of: the pattern (30), dielectric substrate (22), ground plane (24), bracket (26), and RF connector (28). The enclosure consists of a folding carton (40). Referring to FIG. 8, the hanger kit comprises four units, each consisting of: a length of shock cord (64), hook (66), knot (68), and crimp (70). Each of these is described below.

### Function

The current invention functions as a microstrip antenna. Signal originates externally and couples through a coaxial cable and coaxial cable connector, which mates to the RF connector (28). The signal ground couples to the bracket (26), which is coupled to the ground plane (24). The signal couples from the connector pin (29) to the transmission line (31) and then to the antenna (21) by an edge-feed. The dielectric substrate (22) provides an electrically stable environment and spaces the pattern (30) from the ground plane (24).

The hanger kit provides a method of suspending the antenna system from an object such as a wire mesh by providing hooks (66) connected to a shock cord (64) by a crimp (70), which couples to the base antenna (20) by a knot (68) through the attachment holes (23) in the dielectric substrate (60), reinforced by a washer (62).

### Base Antenna

The antenna (21) is a square microstrip “patch” antenna with two slots in opposing corners of the square. It is well known that numerous alternative configurations are possible with equal effect, such as a circular antenna with similar slots, a square antenna with one slot, a rectangular antenna with no slots, etc. One aspect of the invention is that the slots are on the exterior of the antenna (21) so that the pattern (30) can be die cut and stripped without any knock-out components required, reducing the complexity and cost of manufacture.

The base antenna (20) consists of five elements: a ground plane (24), dielectric substrate (22), pattern (30), RF connector (28), and bracket (26). The pattern (30) a metal foil or foil-laminate, preferably made from an aluminum alloy such as 1100, 1145, or similar alloy for maximum conductivity and minimal expense, and approximately 1 to 2 mils thick. Alternatively, copper foil, or various foil laminates may be used. The pattern (30) consists of a microstrip transmission line (31) and antenna (21). The antenna (21) is fed through transmission line (31) along one of the edges. The microstrip transmission line (31) is used to couple electromagnetic radiation to and from the antenna (21), and to transform the large antenna edge impedance to the coaxial line impedance of 50 Ohms. In one embodiment, a pair of transmission lines with different characteristic impedance is used in series to transform the large antenna impedance to approximately 50 Ohms at the RF connector.

The ground plane (24) is a metal foil or plate that covers all or the great majority of the bottom side of the dielectric substrate (22). Preferably, the ground plane (24) is a foil, made from an aluminum alloy such as 1100, 1145, or similar alloy for maximum conductivity and minimal expense, approximately 1 to 2 mils thick, and adhered to the bottom of the dielectric substrate (22) by a pressure sensitive or permanent adhesive such as a hot melt adhesive. Alternatively, other foil or foil-laminates may be used, such as an aluminum-polyester laminate. Thicker foils or plates may be used to add rigidity.

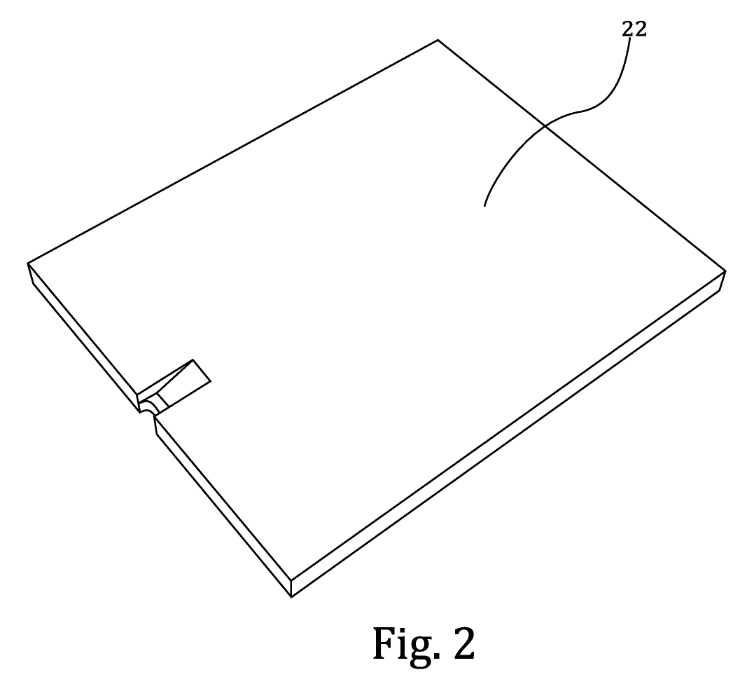

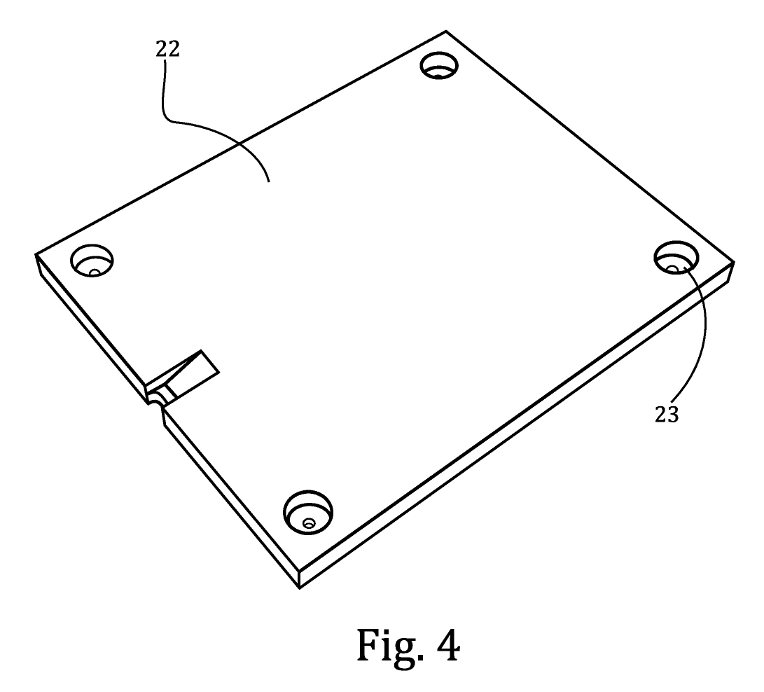

The dielectric substrate (22) (FIGS. 2 and 4) consists of a foamed polymer. Preferably, the foam is an extruded polystyrene (XPS) foam, shaped approximately as a cuboid with a small area near the feed used for a transition to the RF connector (28). A taper transition is placed in the foam block to facilitate a transition from the top of the foam (¾ inches or 19 mm from the ground plane) to the middle of the foam (approximately ⅜ inches or 9.5 mm from the ground plane), i.e., the level of the RF connector (28). Other foams may be used, such as expanded polystyrene (EPS), polyethylene, rubber, or other polymer.

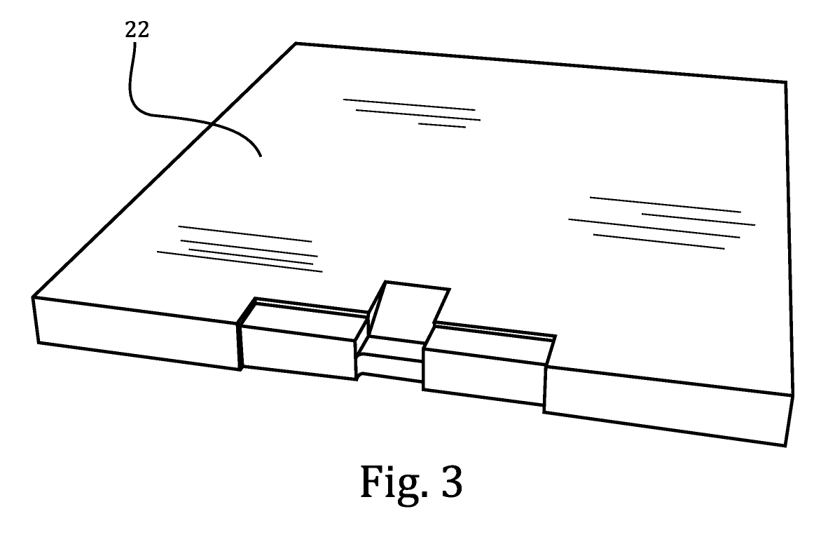

An alternative design (FIG. 3) to the dielectric substrate (22) has a portion of the foam removed around the bracket (26), with the thickness of the bracket, so that the bracket is flush with the top, bottom, and edge of the dielectric substrate (22). This design requires more steps to machine the foam or a more complex mold, but yields a geometry that more closely that of a rectangular cuboid. This geometry makes fabricating an enclosure and stacking antennas into cases for shipping simpler and more efficient.

The pattern (30) consists of a shape cut into the foil preferably by die cutting in a roll-to-roll process. This method of manufacture can produce large metalized shapes with sufficiently precise tolerances quickly and inexpensively. The foil may be supported by a carrier, such as a polyester film, or the release liner. The foil shape is designed so that it can be cut as a tape and stripped readily with a die-cutting operation. The pattern (30) consists of the antenna (21) and microstrip transmission line (31). The microstrip transmission line (31) is further comprised of two sections of transmission lines with different widths, and thus different characteristic impedances. Other arrangements with similar effect are contemplated.

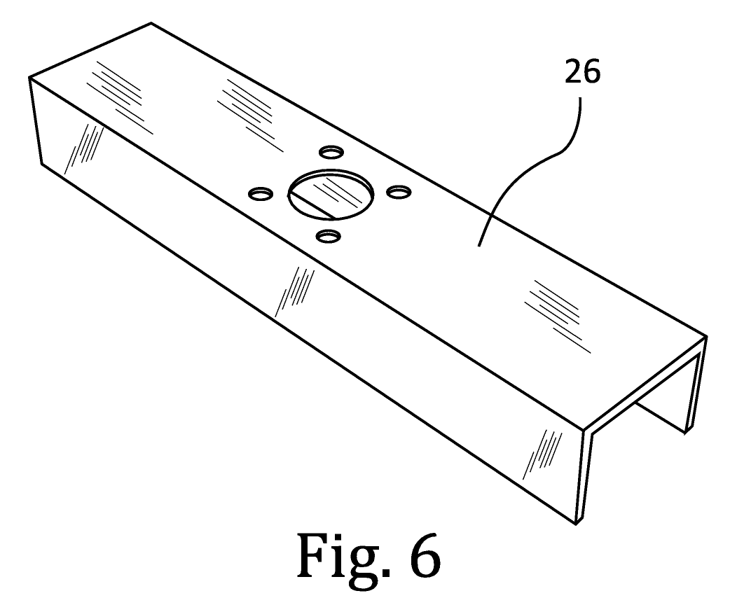

The bracket (26) (FIG. 6) is preferably constructed from an extruded aluminum U channel cut to approximately 4.5 inches in length, and in one embodiment, five holes drilled or punched for mating with the RF connector (28). In another embodiment, one D-shaped hole is punched for mating with the RF connector (28), and four other holes are punched or drilled to be compatible with a VESA-75 or VESA-100 standard mount. The bracket (26) serves a number of purposes. First, the bracket (26) is used to securely mount the RF connector (28). Second, the bracket (26) provides a low impedance electrical connection from the ground of the RF connector (28) to the antenna ground plane (24). Third, the bracket (26) provides physical shelter for the electrical connection between the RF connector (28) and the pattern (30). Any strong force on the attached cable will be transferred directly to the dielectric substrate (22), protecting the electrical connection. Also, any impact in the vicinity of the RF connector (28) will also protect the electrical connection. Adhesive such as epoxy, pressure sensitive acrylic, or polyurethane glue is used to adhere the bracket (26) to the dielectric substrate (22) and ground plane (24). If adhesive is used between the bracket (26) and ground plane (24), it is preferably used along the edges of the bracket (26), so as not to interfere with the electrical connection between the bracket (26) and ground plane (24). Any thin oxide layer between the bracket (26) and ground plane (24) over a large area will provide a very large capacitance, which at UHF frequencies is essentially a short circuit.

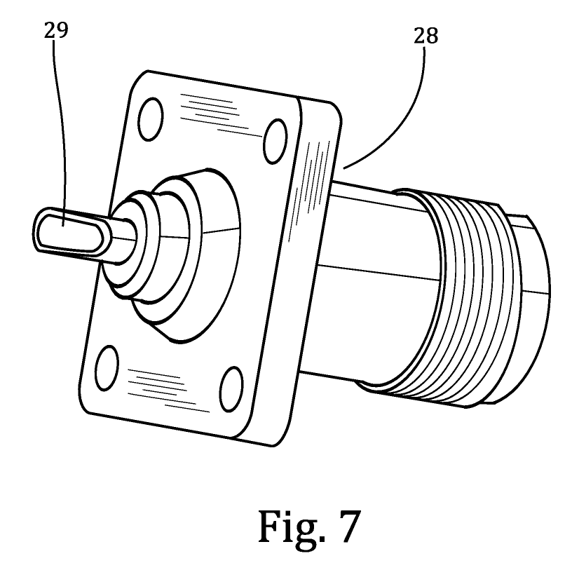

The RF connector (28) (FIG. 7) is used to transition the RF signal from that of a coaxial electromagnetic propagating wave to a microstrip electromagnetic propagating wave. The preferred embodiment uses a TNC or reverse-polarity TNC connector, such as Amphenol 31-2300 or 031-5694. The RF connector (28) is connected to the bracket (26) by rivets, bolts, or similar fastener. Alternatively, a connector such as Amphenol 31-2301-RFX with a 9.7 mm D-hole in the bracket (26) and secured by a nut and thread locking adhesive.

The pattern (30) and RF connector pin (29) are electrically connected through one of several means. If the pattern (30) consists of copper, then it is easy to solder the connector pin (29) and pattern (30) together. If the pattern (30) is aluminum, then solder is more difficult but possible with a suitable tin/zinc solder such as 91/9 tin/zinc solder. Alternatively, one may use conductive adhesives such as nickel, nickel-plated copper, or silver-based epoxy, acrylic, or rubber adhesive. The conductive adhesive can be reinforced by, for example, encapsulating the conductive bond with an epoxy.

Note that the metals of the preferred embodiment are chosen to minimize any galvanic corrosion. The RF connector (28) is nickel-plated, which resists corrosion; aluminum rivets used in one embodiment to connect the RF connector (28) to the bracket (26), and the bracket (26) and ground plane (24) are also aluminum-aluminum junctions. The preferred 6061 (or alternatively 3003) aluminum alloy used in the bracket (26) and preferred 1100 series aluminum alloy used in the ground plane (24) have very similar galvanic properties. Solder to aluminum may be made using a suitable tin/zinc solder such as 91/9 tin/zinc, or any number of suitable solders if bonding to copper. Thus, the long-term electrical connectivity between elements is preserved.

### Enclosure

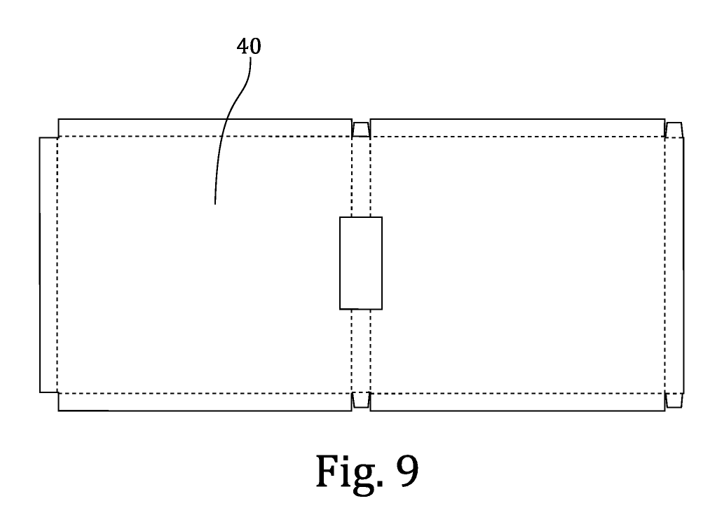

The base antenna (20) may optionally be enclosed in an enclosure (40). The enclosure (40) consists of a low-cost covering material such as chip board, card stock, or corrugated paperboard. This serves as protection against normal wear from the environment, is inexpensive, and available through high speed and commodity processes. Furthermore, the paperboard encapsulation may be readily printed any color or combination of colors, as well as take a glossy finish such as an aqueous or UV coating in order to be easily cleaned with a damp cloth. An example of an enclosure (40) is shown in FIG. 9, where the solid lines denote the cut lines, and the dashed lines denote crease lines. For outdoor applications, a plastic enclosure may be used in place or in addition to the low-cost covering.

### Hanger Kit

Referring to FIG. 8, the optional hanger kit consists of: special recesses (23) that are machined or formed in the dielectric substrate (22) (FIG. 4), a section of cord (64), a washer (62), a metal S hook (66), a knot (68), and a crimp (70). The hook assembly comprises a cord (64), washer (62), hook (66), knot (68), and crimp (70). In one embodiment, the recess in the dielectric substrate (22) consists of an approximately one inch diameter recess through approximately half the thickness of the dielectric substrate (22), and a smaller approximately 0.375 inch diameter hole, centered in the larger recess, through the remainder of the dielectric substrate (22) and ground plane (24). The washer (62) is used to reinforce the recess. Then cord (64) is placed through the small hole of recess (23). The knot (68) end of the cord (64) is functionally aligned with washer 62. An S hook (66) is secured and clamped to the cord (64), and the cord (64) is crimped to secure the hook with crimp (70). Four such assemblies are placed on the four corners of dielectric substrate (22). The hanger kit allows an operator to easily hang the base antenna (20) from a horizontal wire mesh or similar surface. One skilled in the art understands that simple substitutions of elements are possible for similar effect.

We claim the following:

1. An microstrip antenna comprising: a patch antenna having a microstrip transmission line coupled to an edge of the patch antenna, an RF connector, a dielectric substrate, a ground plane, and a bracket, wherein the patch antenna is comprised of a metal foil, the ground plane is comprised of a metal foil, the dielectric is comprised of a foamed polymer, said patch antenna and ground plan being placed on opposite sides of the dielectric substrate, said bracket is a substantially U-shaped with a means for functionally attaching the RF connector, the bracket substantially encloses and protects an electronic connection between the RF connector and the microstrip transmission line and is affixed to the dielectric substrate.

2. The antenna of claim 1, wherein the antenna is comprised of aluminum foil.

3. The antenna of claim 1, wherein the antenna is comprised of aluminum foil backed with a pressure sensitive adhesive.

4. The antenna of claim 1, wherein the antenna is comprised of copper foil.

5. The antenna of claim 1, wherein the antenna is comprised of copper foil backed with a pressure sensitive adhesive.

6. The antenna of claim 1, wherein the foamed polymer is foamed polystyrene.

7. The antenna of claim 1, wherein the foil ground plane is aluminum foil

8. The antenna of claim 1, wherein the foil ground plane is copper foil

9. The antenna of claim 1, wherein the U-shaped bracket is comprised of aluminum

10. An microstrip antenna comprising: a patch antenna having a microstrip transmission line coupled to an edge of the patch antenna, an RF connector, a dielectric substrate, a ground plane, a bracket, wherein the patch antenna is comprised of a metal foil, the ground plane is comprised of a metal foil, the dielectric substrate is comprised of a foamed polymer, said patch antenna and ground plan being placed on opposite sides of the dielectric substrate, said bracket is substantially U-shaped with a means for functionally attaching the RF connector, the bracket substantially encloses and protects an electronic connection between the RF connector and the microstrip transmission line and is affixed to the dielectric substrate, said dielectric substrate having a plurality of circular recess with concentric holes to receive an attachment means.

11. The antenna of claim 10, wherein the circular recess are reinforced with a plastic shoulder washer.

12. The antenna of claim 10, wherein the attachment means is comprised of a shock cord functionally attached to the antenna though the plurality of concentric holes.

13. An microstrip antenna comprising: a patch antenna having a microstrip transmission line coupled to an edge of the patch antenna, an RF connector, a dielectric substrate, a ground plane, a bracket, and an enclosure wherein the patch antenna is comprised of a metal foil, the ground plane is comprised of a metal foil, the dielectric substrate is comprised of a foamed polymer, said patch antenna and ground plan being placed on opposite sides of the dielectric substrate, said bracket is substantially U-shaped with a means for functionally attaching the RF connector, the bracket substantially encloses and protects an electronic connection between the RF connector and the microstrip transmission line and is affixed to the dielectric substrate and said enclosure comprises a folding carton which encapsulates said patch antenna, dielectric substrate and ground plan.

14. The antenna of claim 13, wherein the folding carton is made of chipboard

15. The antenna of claim 13, wherein the folding carton is made of corrugated paperboard

16. The antenna of claim 13, wherein the folding carton is made of card stock

17. The antenna of claim 13, wherein the enclosure is further encapsulated with a label

18. An microstrip antenna comprising: a patch antenna having a microstrip transmission line coupled to an edge of the patch antenna, an RF connector, a dielectric substrate, a ground plane, a bracket, and an enclosure wherein the patch antenna is comprised of a metal foil, the ground plane is comprised of a metal foil, the dielectric substrate is comprised of a foamed polymer, said patch antenna and ground plan being placed on opposite sides of the dielectric substrate, said bracket is substantially U-shaped with a means for functionally attaching the RF connector, the bracket substantially encloses and protects an electronic connection between the RF connector and the microstrip transmission line and is affixed to the dielectric substrate and said enclosure comprises a folding carton which encapsulates said patch antenna, dielectric substrate and ground plan, said dielectric substrate having a plurality of circular recess with concentric holes to receive an attachment means.

19. The antenna of claim 18, wherein the circular recess are reinforced with a plastic shoulder washer.

20. The antenna of claim 18, wherein the attachment means is comprised of a shock cord functionally attached to the antenna though the concentric hole.

21. The antenna of claim 18, wherein the folding carton is made of corrugated paperboard

22. The antenna of claim 18, wherein the folding carton is made of card stock

23. The antenna of claim 18, wherein the enclosure is further encapsulated with a label
